(19) United States
(12) Patent Application Publication
(10) Pub. No.: US 2003/0212149 A1
(43) Pub. Date: Nov. 13, 2003

(54) Foaming apparatus and method

(76) Inventors: Steven R. Grundmann, Duncan, OK (US); Kenneth G. Neal, Duncan, OK (US)

Correspondence Address: JOHN W. WUSTENBERG, P.O. BOX 1431, 2600 SOUTH 2ND STREET, DUNCAN, OK, 73536, US

(21) Appl. No.: 10/456,373

(22) Filed: Jun. 6, 2003

Related U.S. Application Data
(63) Continuation-in-part of application No. 09/932,603, filed on Aug. 17, 2001, now Pat. No. 6,602,916.

(51) Int. Cl. C09K 3/00

(52) U.S. Cl. 516/10

(57) ABSTRACT

A foaming apparatus and method according to which a mixture of gas and a liquid is introduced into a vessel and passes through a passage in the vessel. The flow of the mixture through the passage is increased to increase the velocity of the mixture and cause corresponding shearing forces on the mixture to create a turbulance and form foam from the mixture. The restrictor can be moved in the passage to vary the amount of restriction and therefore the amount of the foam.

### CROSS-REFERENCE TO RELATED APPLICATION

This application is a continuation-in-part of co-pending application Ser. No. 09/932,603 filed Aug. 17, 2001.

### BACKGROUND

This invention relates to an apparatus and method for foaming a liquid/gas mixture.

Foamed liquids are often desirable in many applications such as, for example, the production of oil, gas, or geothermal liquids from the earth. For example, a foamed cement slurry is often introduced in the annulus between the outer surface of a casing and the inner surface of a well to secure the casing in the well. The foam is usually produced by mixing a gas, such as nitrogen, with the cement slurry in a manner to form a foam and then introducing the mixture into the well.

In these arrangements, it is desirable to create a fine, textured foam by creating relatively high shearing forces on the liquid/gas mixture. However, in connection with cementing relatively shallow wells, the ultimate pressure of the cement slurry is relatively low and therefore the mass of the gas required to lighten the cement is also relatively low, which reduces the energy available to create the high shearing forces. Also, some previous attempts to form foamed cement slurries include discharging a gas, such as nitrogen, at a very high velocity, into a tee into which a cement slurry is introduced in a flow path extending ninety degrees to the flow path of the gas. However, the gas must be discharged into the cement slurry at very high velocities to create shearing forces sufficient to produce a fine textured foam which renders it difficult to control the direction of the resulting gas/cement slurry mixture. Producing the high pressure gas requires special and expensive pumping equipment not normally used in cementing operations.

### SUMMARY

Therefore, according to an embodiment of the invention, a mixture of gas and a liquid is introduced into a vessel at a predetermined velocity and passes through a passage in the vessel. The flow of the mixture through the passage is increased to increase the velocity of the mixture and cause corresponding shearing forces on the mixture to create a turbulence and form foam from the mixture. A restrictor can be moved in the passage to vary the amount of restriction and therefore the quality of the foam.

### BRIEF DESCRIPTION OF THE DRAWINGS

FIG. 1 is a cross-sectional view of an apparatus for foaming a liquid according to an embodiment of the invention.

FIG. 2 is a view, similar to that of FIG. 1, but depicting the apparatus in a different operating mode.

### DETAILED DESCRIPTION OF THE PREFERRED EMBODIMENT

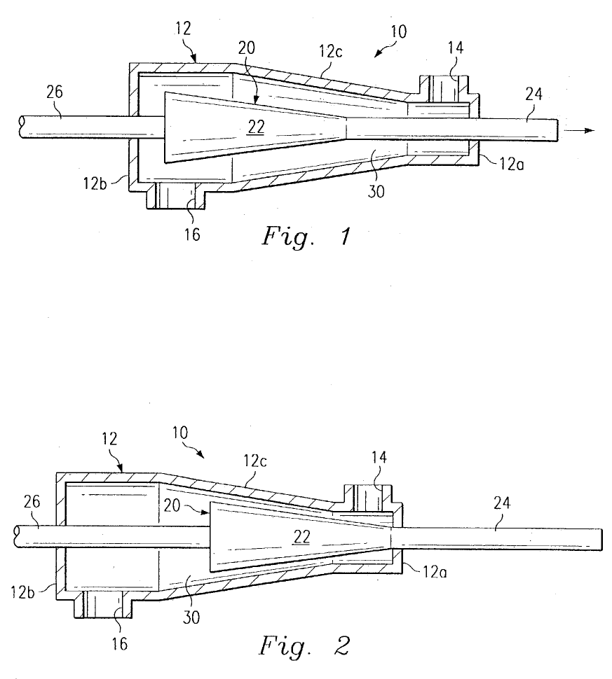

Referring to FIG. 1 of the drawings, the reference numeral 10 refers, in general, to an apparatus for foaming a liquid according to an embodiment of the invention. For the purposes of example, the liquid will be described as a cement slurry of the type normally used in the production of oil, gas, or geothermal liquids from the earth. The apparatus 10 includes an elongated pressure vessel 12 having a circular cross section and including two end walls 12a and 12b, a radially extending inlet 14 near the end wall 12a, and a radially extending outlet 16 near the end wall 12b. The remaining wall of the vessel 12 includes a frusto-conical portion 12c extending between the inlet 14 and the outlet 16.

A flow restrictor, in the form of a spool 20, is disposed in the vessel 12 with its longitudinal axis coinciding with the longitudinal axis of the vessel 12. The spool 20 consists of a frusto-conical base 22 and a cylindrical stem 24 extending from the smaller end of the base 22. The base 22 extends within the vessel 12 and the stem 24 has a portion extending in the vessel 12 and a portion projecting through an opening extending through the end wall 12a of the vessel 12. Preferably the stem 24 is formed integrally with the base 22.

A rod, or shaft, 26 extends through an opening in the end wall 12b of the vessel 12 and is connected, at one end, to the larger end of the base 22. It is understood that the other end of the rod 26 is connected to a device for applying a force to the rod 26 in an axial direction, which force is transmitted to the spool 20 in a direction shown by the arrow. The applied force is relatively constant and independent of the axial position of the spool 20. The applied force could be adjusted during the foaming process to change the quality of the foam. A non-limiting example of this force-applying device is a pneumatic or hydraulic cylinder which is not shown since it is well known in the art. The force applying device could also be attached to the stem 24 at the other end of the vessel 12. Conventional sealing means such as seals (not shown) can be provided where the stem 24 extends through the end wall 12a and the rod 26 extends through the end wall 12b.

An annular passage 30 is formed between the outer surface of the spool 20 and the corresponding inner surface of the vessel 12. The annular passage 30 forms a restricted flow path for a liquid introduced into the inlet 14 as will be described.

Due to the frusto-conical shape of the base 22 of the spool 20 and the wall 12c of the vessel 12, the cross-sectional area of the annular passage 30 can be varied by axial movement of the spool 20 in the vessel 12. Particularly, in the position of FIG. 1, the larger diameter portion of the base 22 of the spool 20 is axially aligned with the larger diameter portion of the wall 12c of the vessel 12, and the size of the restricted flow path is at a maximum. If the spool 20 is moved in a left-to-right direction, as viewed in the drawings, to the position of FIG. 2, the larger diameter portion of the base 22 is axially aligned with the smaller diameter portion of the of the wall 12c. The size of the annular passage 30 is thus reduced when compared to the position of FIG. 1. Of course, the precise location of the spool 20 in the vessel 12 is variable between the two positions of FIGS. 1 and 2 to vary the area of the annular passage 30 forming the restricted flow path.

FIG. 2 depicts the relatively small-diameter portion of the base 22 of the spool 20 abutting the inner surface of the end wall 12a defining the above-identified opening, which therefore limits the axial movement of the spool 20 in a left-to-right direction as viewed in the drawings. Similarly, movement of the spool 20 in a right-to-left direction, as viewed in the drawings will terminate when the large end of the base 22 engages the inner surface of the end wall 12b.

In operation, an external force applied to the spool 20 via the rod 26 will initially locate the spool 20 in an axial position in the vessel 12 such as that shown in FIG. 2. A mixture of a liquid, such as a cement slurry, and a gas, such as nitrogen, is introduced at a certain flow rate into the inlet 14 in a radial direction relative to the vessel 12. The mixture entering the vessel 12 encounters the restricted flow path formed by the annular passage 30 which significantly increases the velocity of the mixture and causes corresponding shearing forces on the mixture, with the resulting turbulence creating a foam from the liquid and gaseous components. The shearing and turbulence cause a pressure differential between the inlet 14 and the outlet 16. This pressure differential acts on the base 22 and causes a force acting to the left. This force opposes the external force applied to the rod 26. When the force generated by the pressure differential acting on the base 22 is equal to the external force applied to the rod 26, the spool 20 will be in an equilibrium position. The spool 20 will remain approximately in the equilibrium position unless the pressure differential changes because of a change in the flow rate of the mixture, fluid mixture properties, etc., or there is a change in the external force applied to the rod 26. The foamed mixture then discharges from the vessel 12 via the outlet 16, and can then be introduced into a wellbore, or the like, in connection with the recovery processes discussed above. The size of the restricted flow path formed by the annular passage 30, and therefore the degree of foaming, can be varied by changing the external force causing a change in the pressure differential and a movement of the spool 20 axially relative to the vessel 12 in the manner discussed above.

Due to the force being applied on the spool 20 as described above, the pressure drop across the inlet 14 of the vessel 12 to the outlet 16 is substantially constant over a range of flow rates of the mixture through the vessel 12. An increase of the flow rate of the mixture will increase the velocity of the mixture in the restricted flow path. The increased velocity will increase fluid turbulence and shearing which will increase the pressure difference between the inlet 14 and the outlet 16. This increased pressure will act on the surface of the base 22 and cause a larger force to be exerted on the base 22. If this force exerted on the base 22 is greater than the force exerted on the rod 26, the spool 20 moves to the left. This movement will increase the cross sectional area of the restricted flow path, thus decreasing the velocity of the mixture. This decreased velocity will decrease turbulence and shearing in the mixture and decrease the pressure difference between the inlet 14 and the outlet 16. As the spool 20 moves to the left the force caused by the differential pressure between the inlet 14 and the outlet 16 will decrease until it is equal to the external force applied to the rod 26. A decrease in flow rate will have an opposite effect causing the spool 20 to move to the right.

Since a portion of the stem 24 extends out from the vessel 12, the operation of the apparatus 10 is independent of the pressures at the inlet 14 and outlet 16. Normally, an increase in the pressure at the outlet 16 would raise the pressure at the inlet 14 an equal amount. If the diameters of the rod 26 and the stem 24 are equal, then the projected area in the axial direction of the right side of the base 22 along the axis of the spool 20 is equal to the projected area in the axial direction of the left side of the base 22 along the axis of the spool 20. Equal increases in the pressures at the inlet 14 and outlet 16 acting on the equal projected areas of the left side and right side of the base 22 will cause equal but opposite forces. These forces will cancel each other, leaving only the external force applied to the rod 26 and the force caused by the pressure differential in the restricted flow path to affect the position of the spool 20. Although the diameters of the rod 26 and the stem 24 and the projected areas in the axial direction of the right side and left side of the base 22 along the axis of the spool 20 are preferably equal, substantial equality resulting in substantially equal but opposite forces on the base 22 are acceptable.

Thus, the present apparatus and method enjoys several advantages. For example, the energy available to create the shearing forces to make the fine textured foam is relatively high. Also, the gas portion of the gas/cement slurry mixture does not have to be at high pressure relative to the liquid component of the mixture, which enables the direction of the mixture exiting the outlet 16 of the vessel 12 to easily be controlled.

It is understood that variations can be made in the foregoing without departing from the scope of the invention. For example, a gas other than nitrogen can be mixed with the cement and a liquid other than cement, can be used within the scope of the invention. Also the term “cement” and “cement slurry” as used above, is meant to cover mixtures of cement, water and/or other additives consistent with conventional downhole technologies. Further, the specific shape of the vessel 12 and the spool 20 can be varied as long as the cross-sectional area of the flow passage, and therefore the restriction, can be varied. For example, the vessel 12 can have a consistent cross section along its axis and the spool 20 can have a variable cross section, or vice versa; and, in fact other variable choke devices can be used. In addition, external force does not have to be applied to the rod 26 before the mixture is introduced into the inlet 14. Also, liquid can be introduced into the inlet 14 for a period of time before gas is added to form the mixture.

Since other modifications, changes, and substitutions are intended in the foregoing disclosure, it is appropriate that the appended claims be construed broadly and in manner consistent with the scope of the invention.

What is claimed is:

1. A method of generating foam, comprising the steps of:
providing a mixture of gas and liquid;
introducing the mixture into a vessel having a flow restrictor;
applying an external force to the flow restrictor; and
foaming the mixture by flowing the mixture through a passage defined by an outer surface of the flow restrictor and an inner surface of the vessel;
wherein the position of the flow restrictor in the vessel is determined by the external force applied to the flow restrictor and the flow rate of the mixture.

2. The method of claim 1 wherein:
the vessel has an inlet for receiving the mixture;
the vessel has an outlet for discharging the foamed mixture; and
a pressure drop across the inlet to the outlet is substantially constant over a range of flow rates of the mixture through the vessel.

3. The method of claim 2 wherein the pressure drop between the inlet and the outlet causes a force to act on the flow restrictor that opposes the external force applied to the flow restrictor such that the flow restrictor maintains an equilibrium position when the forces are equal.

4. The method of claim 1 wherein the vessel varies in cross-sectional area such that movement of the flow restrictor varies the area of the passage.

5. The method of claim 1 wherein the restrictor varies in cross-sectional area such that movement of the flow restrictor varies the area of the passage.

6. The method of claim 1 wherein the cross-sectional area of the vessel and the flow restrictor vary such that movement of the flow restrictor varies the area of the passage.

7. The method of claim 1 wherein the restrictor is in the form of a spool having a circular cross-section.

8. The method of claim 7 wherein the spool varies in cross-section along its length.

9. The method of claim 1 wherein the gas is nitrogen and the liquid is cement slurry.

10. A foaming apparatus comprising:
a vessel;
an inlet located on the vessel for receiving a mixture of gas and liquid;
an outlet located on the vessel for discharging the mixture, wherein the vessel defines a passage extending from the inlet to the outlet; and
a spool having a longitudinal axis disposed in the passage for restricting the flow of the mixture through the passage, wherein the spool comprises:
a base having a first side and a second side;
a rod extending from the base; and
a stem extending from the base;
wherein:
a diameter of the rod is substantially equal to a diameter of the stem;
a projected area of the first side of the base along the axis of the spool is substantially equal to a projected area of the second side of the base along the axis of the spool; and
the spool is movable in the passage to vary the amount of restriction.

11. The foaming apparatus of claim 10 wherein the base has a first end that engages a first end of the vessel to limit movement of the spool in a first direction and a second end that engages a second end of the vessel to limit movement of the spool in a second direction.

12. The foaming apparatus of claim 10 wherein the vessel has a varying cross-sectional area such that movement of the spool in the passage varies the amount of the restriction.

13. The foaming apparatus of claim 12 wherein the rod and stem extend through walls of the vessel.

14. The foaming apparatus of claim 13 further comprising seals for sealing the vessel where the rod and stem extend through the walls of the vessel.

15. A method of generating foam from a mixture of gas and liquid, comprising the steps of:
providing a vessel having a flow restrictor;
applying an external force to the flow restrictor;
foaming the mixture by flowing the mixture through a passage defined by an outer surface of the flow restrictor and an inner surface of the vessel; and
positioning the flow restrictor in the vessel by balancing the external force with a force acting on the flow restrictor created by the flow of the mixture through the passage.

16. The method of claim 15 wherein:
the vessel has an inlet for receiving the mixture;
the vessel has an outlet for discharging the foamed mixture; and
a pressure drop across the inlet to the outlet is substantially constant over a range of flow rates of the, mixture through the vessel.

17. The method of claim 15 wherein the vessel varies in cross-sectional area such that movement of the flow restrictor varies the area of the passage.
